(19) United States
(12) Patent Application Publication
(10) Pub. No.: US 2019/0251556 A1
(43) Pub. Date: Aug. 15, 2019

(54) DISTRIBUTED LEDGER ON-BOARDING SYSTEM FOR STANDBY GUARANTEE RESOURCES

(71) Applicant: BANK OF AMERICA CORPORATION, Charlotte, NC (US)

(72) Inventors: Ann Elizabeth Flaherty McCormick, Cape Elizabeth, ME (US); Nirmalya Banerjee, Charlotte, NC (US); David James McGinness, Stallings, NC (US); Elizabeth Anne Prudden, Charlotte, NC (US); Deepak Mysore Shamarao, Charlotte, NC (US); Robin Elizabeth Tooker, Charlotte, NC (US); Mark D. Zanzot, Huntersville, NC (US); Colin Zeglen, Dalton, PA (US)

(73) Assignee: BANK OF AMERICA CORPORATION, Charlotte, NC (US)

(21) Appl. No.: 16/182,303

(22) Filed: Nov. 6, 2018

Related U.S. Application Data
(60) Provisional application No. 62/629,440, filed on Feb. 12, 2018.

(51) Int. Cl. G06Q 20/38; G06F 17/30; G06Q 20/24; G06Q 20/40

(52) U.S. Cl. CPC G06Q 20/389; G06F 17/30283; H04L 9/0637; G06Q 20/24; G06Q 20/405; G06F 17/30377

(57) ABSTRACT

Embodiments of the invention are directed to a system, method, or computer program product for onboarding members to a block chain based distributed ledger system for standby guarantee resources applications, submissions, and approvals for party visualization. In this way, the invention provides automation of standby guarantee resources utilizing block chain distributed ledger technology to provide full transactional transparency to all parties, enforcement of configurable rules terms, and enforcement of contractual terms, routing expedition, data integration, and authentication.

### CROSS-REFERENCE TO RELATED APPLICATION(S)

This application is a non-provisional filing of U.S. Patent Application No. 62/629,440 filed Feb. 12, 2018, entitled “Distributed Ledger System for Standby Resource Letters,” the contents of which are hereby incorporated by reference.

### BACKGROUND

In multiple party standby guarantee resource applications, submissions, and approvals each of the parties require accurate real-time notifications of the standby guarantee resource approval or distribution. Furthermore, authentication access to various specifics within the standby guarantee resource need to be monitored for appropriate access to information. As a result, there exists a need for an application, submission, and approval ledger with authentication key adaptability.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for block chain based distributed ledger system for standby guarantee resources applications, submissions, and approvals utilizing private key and hash authentication for party visualization.

The invention comprises a designed trade finance digital solution for the automation of standby guarantee resource utilizing block chain distributed ledger technology to provide full transactional transparency to all parties, enforcement of configurable rules and contractual terms via smart contracts, automated routing/business rules, integration to corporate and financial institution applicant/beneficiary directories, permissioning processing, entitlement, and authentication. The system provides full end to end transaction flows, the operational model for the distributed ledger, enhanced security and automation as well as interoperability between clouds and use of APIs and UIs to increase member adoption and includes foundational infrastructure for the addition of other trade finance instruments to the distributed ledger network.

The system provides an onboard of new members to the block chain network based on new applicant/beneficiary request, key generation, and installation of software packaging. The system then requires member approval for new member onboarding. Once the members log into the network and authenticate and authorize to the network, the system may allow for approval for submission to the ledger. The application may then be broadcasted to the other nodes on the ledger that, based on their level, need to see the application in its current status. In this way, at each step of the standby guarantee resources processing, only the nodes that need to perform a function at that processing point gain access to the documentation on the distributed ledger for completion of the task. After broadcasting a consensus of the members must be generated for the issuer to approve or deny the transaction.

Embodiments of the invention relate to systems, methods, and computer program products for onboarding parties for standby guarantee resources generation and processing, the invention comprising: generating a block chain network for a standby guarantee resources and processing; enabling access to the block chain network on a financial institution platform; identifying one or more parties of a transaction and allow access to a distributed ledger associated with the standby guarantee resources generation and processing and transmit entity and administrator data via direct service or UI; onboarding and off boarding of parties via authentication of the parties as members; identifying access of parties and provide tool kit for member access of a distributed ledger based on access via API, UI, or direct service; identifying a request for the standby guarantee resources and generate one or more blocks on a distributed ledger based on the request; and generating a smart contract for processing the standby guarantee resources for triggering of member access and steps for processing the standby guarantee resources.

In some embodiments, members are parties that are identified as entities required for processing and approving the standby guarantee resources or third parties associated with a transaction with an applicant/beneficiary wherein the transaction includes the standby guarantee resources.

In some embodiments, enabling access to the block chain network on a financial institution platform further comprises enabling access to a distributed network on the block chain network via a host or non-host cloud.

In some embodiments, the invention further comprises: presenting the request to one or more parties on the block chain network based on authorization access, allowing processing of the standby guarantee resources via data distribution from the one or more parties; and providing real-time enforcement of configurable rules and contractual terms via distributive ledger visualization of the standby guarantee resources.

In some embodiments, the block chain network provides transparency for all parties of the transaction for real-time enforcement of configurable rules and contractual terms via smart contract and routing integration.

In some embodiments, the invention further comprises allowing processing of the standby guarantee resources via data distribution from the one or more parties further comprises generation of an application for the standby guarantee resources from a resource distribution entity for applicant/beneficiary completion and matching information on the application to documentation generated from the applicant/beneficiary and distributed via the distributed ledger.

In some embodiments, the standby guarantee resources further comprises a standby credit letter for an entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1A provides centralized database architecture environment, in accordance with one embodiment of the present invention;

FIG. 1B provides a high level block chain system environment architecture, in accordance with one embodiment of the present invention;

FIG. 2A provides a high level process flow illustrating node interaction within a block chain system environment architecture, in accordance with one embodiment of the present invention;

FIG. 2B provides a detailed process flow illustrating node interaction within a block chain system environment architecture, in accordance with one embodiment of the present invention;

FIG. 3A provides a high level process map illustrating high level process map illustrating standby guarantee resource request and deployment, in accordance with one embodiment of the present invention;

FIG. 3B provides a high level process map illustrating standby guarantee resource request and deployment, in accordance with one embodiment of the present invention;

FIG. 3C provides a high level process map illustrating components and blocks of network for standby guarantee resource request and deployment, in accordance with one embodiment of the present invention;

FIG. 4 provides a detailed process map illustrating standby guarantee resources member onboarding, in accordance with one embodiment of the present invention;

FIG. 5 provides a detailed process map for financial institution onboarding to a distributed ledger with a hosting cloud client, in accordance with one embodiment of the present invention;

FIG. 6 provides a detailed process map for financial institution onboarding to a distributed ledger with a non-hosting cloud client, in accordance with one embodiment of the present invention;

FIG. 7 provides a detailed process map for entity onboarding to a distributed ledger with a cloud enabled hosting cloud client, in accordance with one embodiment of the present invention;

FIG. 8 provides a detailed process map for entity onboarding to a distributed ledger with a non-hosting cloud enabled client, in accordance with one embodiment of the present invention;

FIG. 9 provides a detailed process map for entity onboarding to a distributed ledger, in accordance with one embodiment of the present invention; and

FIG. 10 provides a standby guarantee resource system environment, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “standby guarantee resource” as used herein may refer to a standby letter of credit. In some embodiments, the standby guarantee resource may include a guarantee or promise of resources issued by a resource distribution entity, such as a financial institution, on behalf of an applicant/beneficiary as a payment of last resort should the applicant/beneficiary desire the resources for fulfillment of a contractual commitment with a third party. The standby guarantee resource is a good faith business transaction sign for proof applicant/beneficiary credit quality requiring a review of applicant/beneficiary resource management by a resource distribution entity and generation of a letter for the third party. A member, as used herein, may include any party associated with the standby guarantee resource, this may include applicants, beneficiaries, issuing institutions, confirming institutions, operators, and the like associated with the standby guarantee resource.

Furthermore, as used herein the term “applicant/beneficiary device” or “mobile device” may refer to mobile phones, personal computing devices, tablet computers, wearable devices, and/or any portable electronic device capable of receiving and/or storing data therein. An “applicant/beneficiary” may be an individual or business requesting or applying for a standby guarantee resource, such as a buyer, supplier, or the like. A member may be any entity or individual associated with the standby guarantee resource transaction, this may include the applicant/beneficiary, issuing financial institution, advising financial institution, third party entities, or the like.

“Block chain” as used herein refers to a decentralized electronic ledger of data records which are authenticated by a federated consensus protocol. Multiple computer systems within the block chain, referred to herein as “nodes” or “compute nodes,” each comprise a copy of the entire ledger of records. Nodes may write a data “block” to the block chain, the block comprising data regarding a transaction. In some embodiments, only permissioned nodes may write transactions to the block chain. In other embodiments, all nodes have the ability to write to the block chain. In some embodiments, the block may further comprise a time stamp and a pointer to the previous block in the chain. In some embodiments, the block may further comprise metadata indicating the node that was the originator of the transaction. In this way, the entire record of transactions is not dependent on a single database which may serve as a single point of failure; the block chain will persist so long as the nodes on the block chain persist. A “private block chain” is a block chain in which only authorized nodes may access the block chain. In some embodiments, nodes must be authorized to write to the block chain. In some embodiments, nodes must also be authorized to read from the block chain. Once a transactional record is written to the block chain, it will be considered pending and awaiting authentication by the permissioned nodes in the block chain.

A “block” as used herein may refer to one or more records of a file with each record comprising data for transmission to a server. In some embodiments, the term record may be used interchangeably with the term block to refer to one or more transactions or data within a file being transmitted.

Embodiments of the present invention address these and/or other needs by providing an innovative system, method and computer program product for block chain based distributed ledger system for standby guarantee resource applications, submissions, and approvals utilizing private key and authentication for party visualization.

The invention comprises a designed trade finance digital solution for the automation of standby guarantee resources utilizing block chain distributed ledger technology to provide full transactional transparency to all parties, enforcement of configurable rules and contractual terms via smart contracts, automated routing/business rules, integration to corporate and financial institution applicant/beneficiary directories, permissioning processing, entitlement, and authentication. The system provides full end to end transaction flows, the operational model for the distributed ledger, enhanced security and automation as well as interoperability between clouds and use of APIs and UIs to increase member adoption and includes foundational infrastructure for the addition of other trade finance instruments to the distributed ledger network.

The invention includes members entering via APIs and UIs. Each member may be at a different level of access of data or different type of authentication based on the type of member. The types of members may include buyers, suppliers, issuing financial institutions, advising financial institutions, or the like. An applicant/beneficiary or applicant may apply for a standby guarantee resource which triggers the system for smart contract generation and deployment. The triggering event of submission of the application allows for members to access the private block chain via UI from entity legacy systems for completion of the necessary steps for the standby guarantee resource. The system may further onboard new members to the block chain network based on new applicant/beneficiary request, key generation, and installation of software packaging. The system then requires member approval for new member onboarding. Once the members log into the network and authenticate and authorize to the network, the system may allow for approval for submission to the ledger. The application may then be broadcasted to the other nodes on the ledger that, based on their level, need to see the application in its current status. In this way, at each step of the standby guarantee resource processing, only the nodes that need to perform a function at that processing point gain access to the documentation on the distributed ledger for completion of the task. After broadcasting a consensus of the members must be generated for the issuer to approve or deny the transaction.

Furthermore, the blocks within each file can only be transmitted to a select group of members depending on their role within the generation, completion, or utilization of the standby guarantee resource. As such, providing specific authentication and access to data based on the individual required role within the standby guarantee resource.

Embodiments of the invention also provide a system for distributing of transaction data associated with the requesting, generating, completing, and utilizing a standby guarantee resource within a private block chain. In some embodiments, each of the nodes on the private block chain are responsible for performing one or more functions to process the transaction. In particular, each node monitors the block chain for blocks that are critical to perform its task while being blocked from or otherwise not being able to visualize the blocks that are not relevant. Upon discovering a relevant block, the node performs its designated functions to process the transaction, i.e. the blocks within the block chain trigger the nodes to perform their functions. Once a block has been authenticated, a node may rely on the data record stored therein without utilizing a complex reconciliation system to confirm the data's integrity. By using the block chain to control the workflow of the transaction, the system may avoid data errors resulting from failure in communications amongst nodes and prevents the need for computing resource-intensive data reconciliation processes.

Embodiments of the invention also provide a system for authorizing block chain transactions by distributed ledger keys. In such an embodiment, each block comprises a transaction record and an authorization key, indicating the originating node (the sender) of the transaction. The nodes within the private block chain comprise a “white list,” comprising a list of authorized senders of the transaction. In this way, a receiving node will only process a transaction in the block chain if the sender is one of the authorized senders on the white list; otherwise, the node rejects the transaction, thereby increasing the security of transactions within the system. In some embodiments, the node may write a rejection block to the block chain.

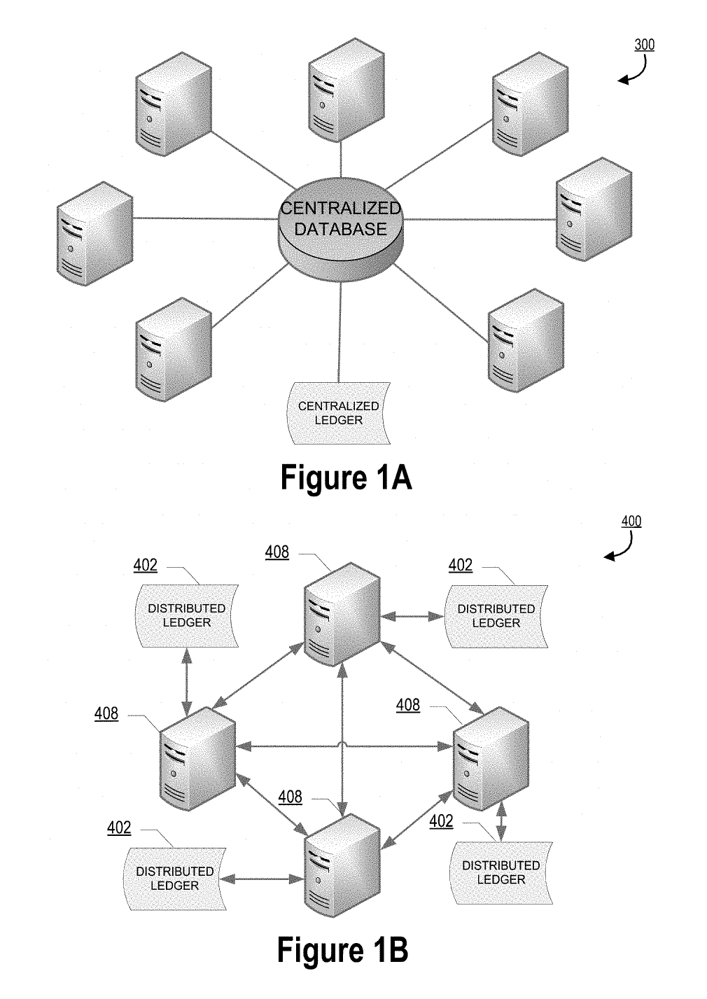

FIG. 1A illustrates a centralized database architecture environment 300, in accordance with one embodiment of the present invention. The centralized database architecture comprises multiple nodes from one or more sources and converge into a centralized database. The system, in this embodiment, may generate a single centralized ledger for data received from the various nodes. The single centralized ledger for data provides a difficult avenue for allowing access and reviewing a block of a data as it moves through the various applications.

FIG. 1B provides a general block chain system environment architecture 400, in accordance with one embodiment of the present invention. Rather than utilizing a centralized database of data for instrument conversion, as discussed above in FIG. 1A, various embodiments of the invention may use a decentralized block chain configuration or architecture as shown in FIG. 1B in order to facilitate the validation or failure location identification for file transmission. Such a decentralized block chain configuration ensures accurate mapping and tagging of blocks within a files during or after the transmission. Accordingly, a block chain configuration may be used to maintain an accurate ledger of files and the processing of transmission of the files by generation of building of one or more blocks for each file of the transmission. In this way, building a traceable and trackable historic view of each file transmission for failure location identification.

A block chain is a distributed database that maintains a list of data blocks, such as real-time resource availability associated with one or more accounts or the like, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator.

A block chain provides numerous advantages over traditional databases. A large number of nodes of a block chain may reach a consensus regarding the validity of a transaction contained on the transaction ledger. As such, the status of the instrument and the resources associated therewith can be validated and cleared by one participant.

The block chain system typically has two primary types of records. The first type is the transaction type, which consists of the actual data stored in the block chain. The second type is the block type, which are records that confirm when and in what sequence certain transactions became recorded as part of the block chain. In some embodiments, the block chain system is closed, as such the number of permissioned nodes in the current system are known and the system comprises primary sponsors that generate and create the new blocks of the system. As such, any block may be worked on by a primary sponsor. Applicant/beneficiary of the block chain create transactions that are passed around to various nodes of the block chain. A “valid” transaction is one that can be validated based on a set of rules that are defined by the particular system implementing the block chain.

As mentioned above and referring to FIG. 1B, a block chain system 400 is typically decentralized—meaning that a distributed ledger 402 (i.e., a decentralized ledger) is maintained on multiple nodes 408 of the block chain 400. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. In some embodiments, the nodes 408 of the system might be financial institutions that function as gateways for other financial institutions. For example, a credit union might hold the account, but access the distributed system through a sponsor node.

Various other specific-purpose implementations of block chains have been developed. These include distributed domain name management, decentralized crowd-funding, synchronous/asynchronous communication, decentralized real-time ride sharing and even a general purpose deployment of decentralized applications.

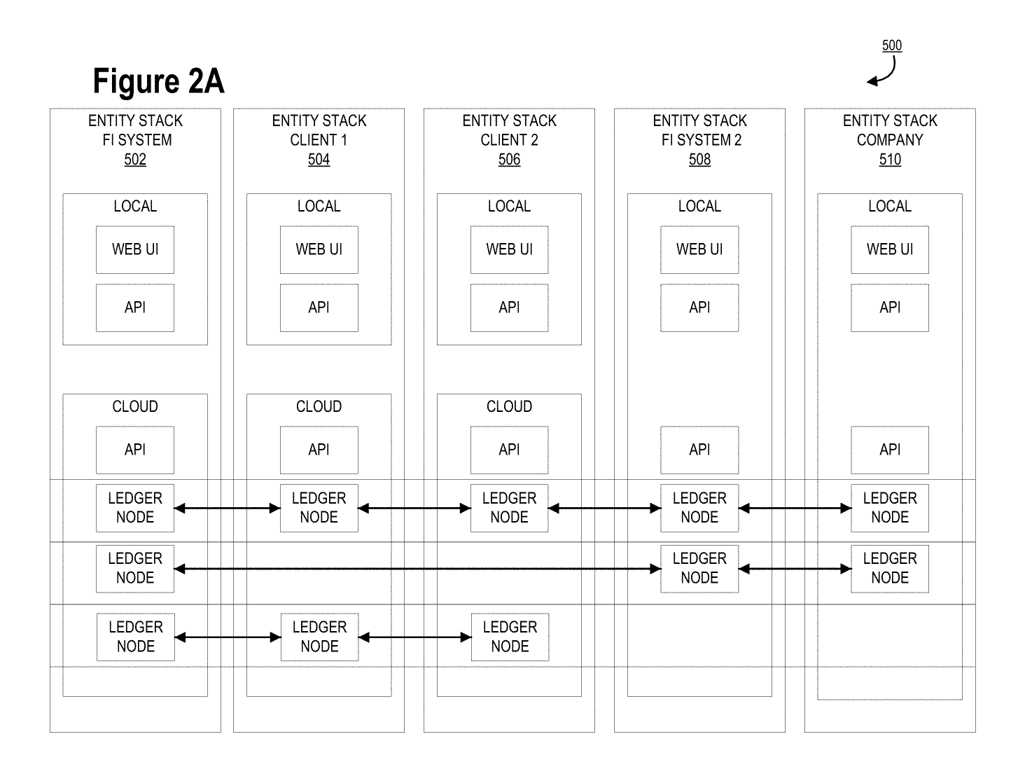

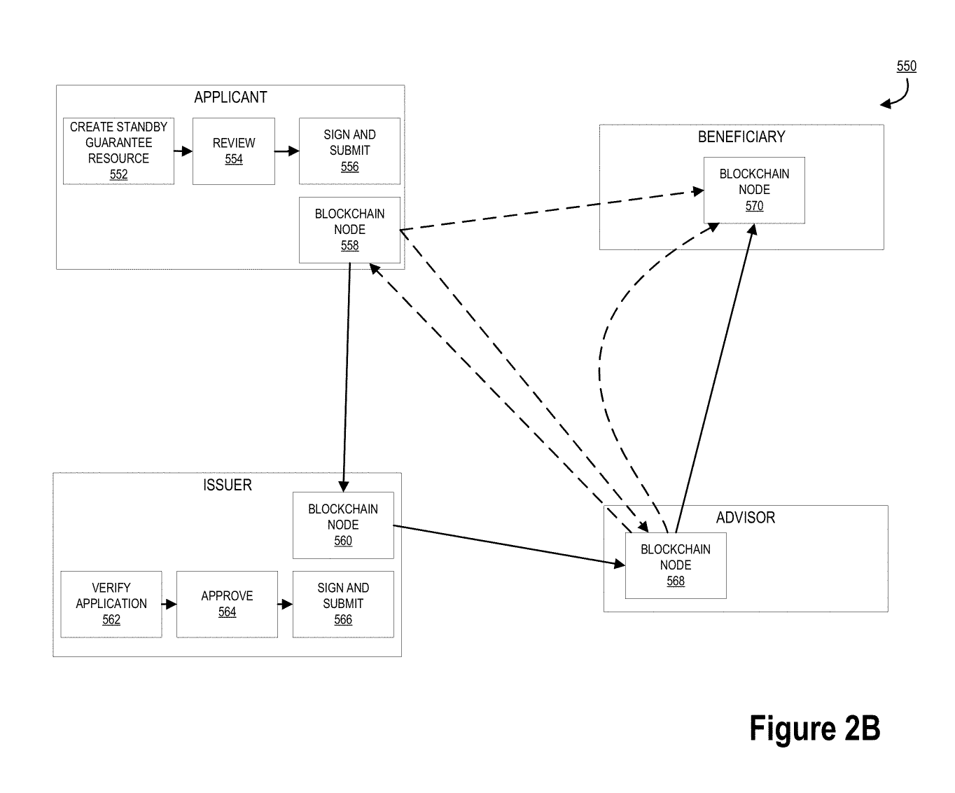

FIG. 2A provides a high level process flow illustrating node interaction within a block chain system environment architecture 500, in accordance with one embodiment of the present invention. As illustrated and discussed above, the block chain system may comprise at least one or more nodes used to generate blocks within file transmission for transmission validation or failure location identification during file transfers across servers. FIG. 2A illustrates stacks for entities associated with the standby guarantee resources block chain network. As illustrated, these stacks may include an entity stack of a financial institution 502, entity stack for client 1 504, entity stack for client 2 506, where client 1 and client 2 may be trade clients. In some embodiments, a stack may include an entity stack for another financial institution 508 associated with the standby guarantee resource processing. The financial institutions may be an issuing institution, a confirming institution or the like. In some embodiments, an entity stack for a company 510 may also be on the block chain network, this may be an entity such as a beneficiary, applicant, operator, or the like.

Locally, within each entity stack, the system comprises a web applicant/beneficiary interface and/or and an application programming interface (API). On the cloud layer, each entity stack that is associated with the cloud also comprises an API.

Furthermore, each stack may comprise one or more ledger nodes based on the entity role within the standby guarantee resource processing. Three ledgers are displayed in FIG. 2A and are stacked vertically across each of the entity stacks. These ledgers include a trade finance ledger, payments ledger, and a loans ledger. The entity stack financial institution system 502 comprises a ledger node in each of the trade finance ledger, payments ledger, and the loans ledger. The entity stacks of client 1 and client 2 504 and 506 comprise a ledger node in trade finance ledger and in the loans ledger for communication across the block chain. Finally, the entity stack associated with the financial institution 2 508 and the company 510 comprise ledgers including the trade finance ledger and the payments ledger.

In some embodiments, the plurality of computer systems are in operative networked communication with one another through a network. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

In some embodiments, the computer systems represent the nodes of the private block chain. In such an embodiment, each of the computer systems comprise the private block chain, providing for decentralized access to the block chain as well as the ability to use a consensus mechanism to verify the integrity of the data therein. In some embodiments, an upstream system and a downstream system are further operatively connected to the computer systems and each other through the network. The upstream system further comprises a private ledger and the private block chain. The downstream system further comprises the private block chain and an internal ledger, which in turn comprises a copy of the private ledger.

In some embodiments, a copy of private block chain may be stored on a durable storage medium within the computer systems or the upstream system or the downstream system. In some embodiments, the durable storage medium may be RAM. In some embodiments, the durable storage medium may be a hard drive or flash drive within the system.

FIG. 2B provides a detailed process flow illustrating node interaction within a block chain system environment architecture 550, in accordance with one embodiment of the present invention. As illustrated an applicant, issuer, beneficiary, and advisor are present in this standby guarantee resource processing. FIG. 2B illustrates system workflow and the mapping of requirements to system design. As illustrated, the process 550 is initiated by the creation of a standby guarantee resource, as illustrated in block 552. Next, the standby guarantee resource is reviewed, as illustrated in block 554. The standby guarantee resource is then signed and submitted as illustrated in block 556. Via the members block chain nodes, all parties may visualize the processing of the standby guarantee resource via notifications and updates to the block chain. The signed and submitted standby guarantee resource may be posted to the block chain and be visible by the issuer, via the issuer block chain node 560. The issuer may verify the application, as illustrated in block 562. Next, as illustrated in block 564, the issuer may approve the application for standby guarantee resource. Subsequently the issuer may sign and submit the standby guarantee resource application, as illustrated in block 566. The standby guarantee resource may then be submitted to the advisor via the advisor block chain node 568. The beneficiary may also visualize and confirm the processing of the standby guarantee resource via the beneficiary block chain node 570.

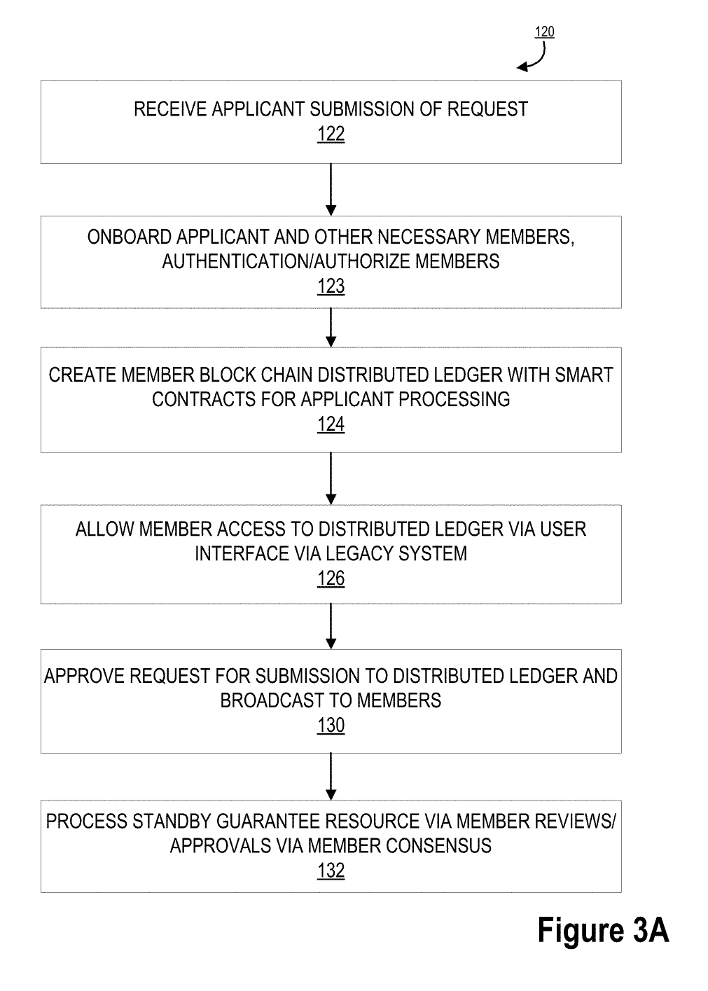

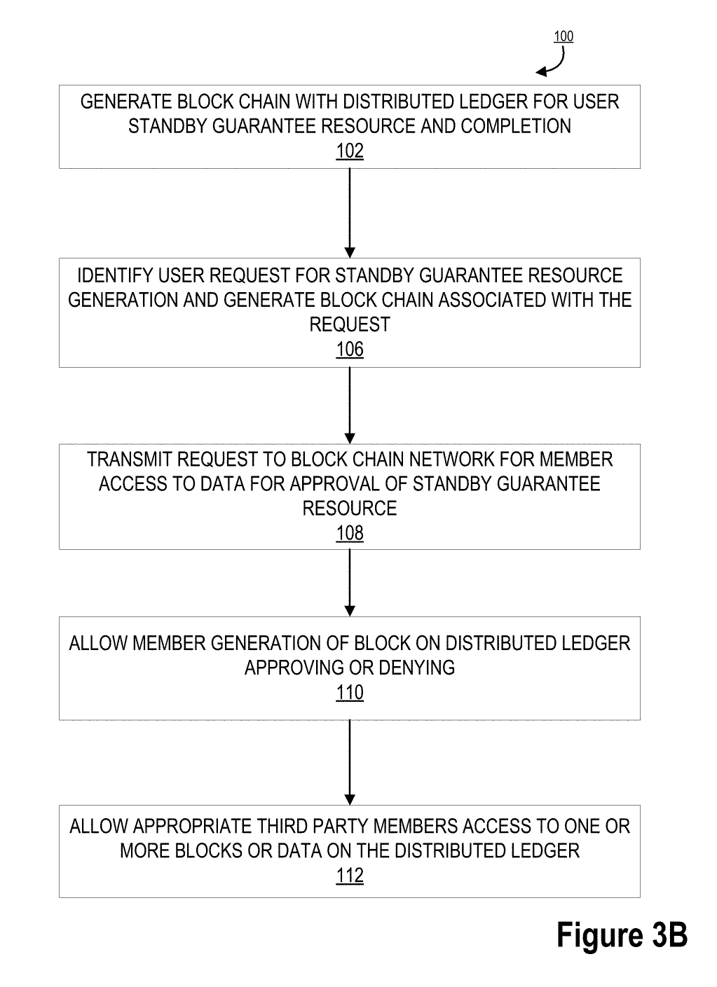

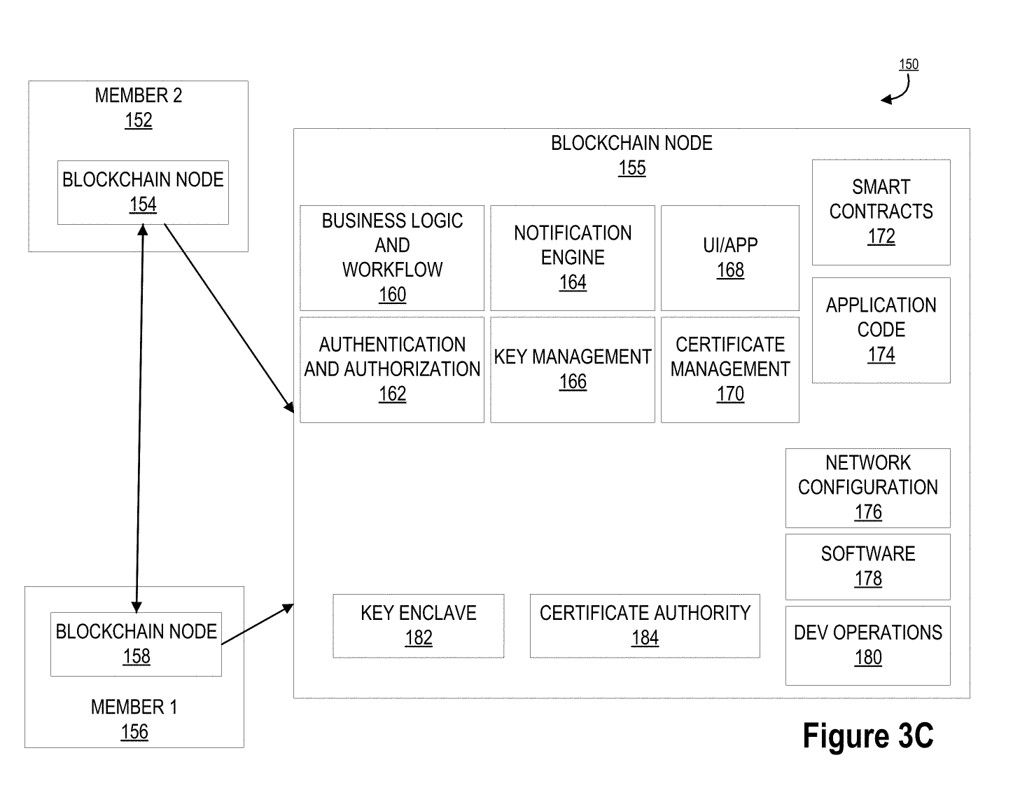

FIG. 3A provides a high level process map illustrating high level process map illustrating standby guarantee resource request and deployment 120, in accordance with one embodiment of the present invention. As illustrated in block 122, the process 120 is initiated by receiving an application submission of request for standby resource guarantee. The invention comprises a designed trade finance digital solution for the automation of standby guarantee resource utilizing block chain distributed ledger technology to provide full transactional transparency to all parties, enforcement of configurable rules and contractual terms via smart contracts, automated routing/business rules, integration to corporate and financial institution applicant/beneficiary directories, permissioning processing, entitlement, and authentication. The system provides full end to end transaction flows, the operational model for the distributed ledger, enhanced security and automation as well as interoperability between clouds and use of APIs and UIs to increase member adoption and includes foundational infrastructure for the addition of other trade finance instruments to the distributed ledger network.

Next, as illustrated in block 123, the process 120 continues by further onboarding new members to the block chain network based on new applicant/beneficiary request, key generation, and installation of software packaging. Along with onboarding, the system may authenticate and/or authorize members into the block chain network. The members may be authenticated and control of access may be performed via verifying addresses of the members. Smart contracts can be written to check for access for every request, applicant/beneficiary credentials and addresses may be stored in a directory service. The system then requires member approval for new member onboarding, based on member consensus. Once the members log into the network and authenticate and authorize to the network, the system may allow for approval for submission to the ledger.

As illustrated in block 124, the process 120 continues by creating a member block chain distributed ledger with smart contracts for applicant standby guarantee resource processing. As illustrated in block 126, the system allows for member access to the distributed ledger via an applicant/beneficiary interfaces associated with entity legacy systems. In this way, the system allows for applicant/beneficiary access to the block chain network via legacy systems. As such, the system takes over a proton of legacy system coding for display and integration of the block chain network for member visualization of documentation on the block chain.

As illustrated in block 130, the process 120 continues by approving request for submission to distributed ledger and the application may then be broadcasted to the other nodes on the ledger that, based on their level, need to see the application in its current status. In this way, at each step of the standby guarantee resource processing, only the nodes that need to perform a function at that processing point gain access to the documentation on the distributed ledger for completion of the task. After broadcasting a consensus of the members must be generated for the issuer to approve or deny the transaction. Finally, as illustrated in block 132, the process 120 is finalized by processing the standby guarantee resource via member reviews and approvals via member consensus. Embodiments of the invention also provide a system for distributing of transaction data associated with the requesting, generating, completing, and utilizing a standby guarantee resource within a private block chain. In some embodiments, each of the nodes on the private block chain are responsible for performing one or more functions to process the transaction. In particular, each node monitors the block chain for blocks that are critical to perform its task while being blocked from or otherwise not being able to visualize the blocks that are not relevant. Upon discovering a relevant block, the node performs its designated functions to process the transaction, i.e. the blocks within the block chain trigger the nodes to perform their functions. Once a block has been authenticated, a node may rely on the data record stored therein without utilizing a complex reconciliation system to confirm the data's integrity. By using the block chain to control the workflow of the transaction, the system may avoid data errors resulting from failure in communications amongst nodes and prevents the need for computing resource-intensive data reconciliation processes.

FIG. 3B provides a high level process map illustrating standby guarantee resource request and deployment 100, in accordance with one embodiment of the present invention. As illustrated in block 102, the process 100 is initiated by generating a block chain network with distributed ledger for the applicant/beneficiary standby guarantee resource generation and completion. The block chain may be a private block chain with keyed access for specific data points and blocks within the distributed network.

Next, as illustrated in block 106, the process 100 continues to identify an applicant/beneficiary requesting a standby guarantee resource generation and the system may generate a block chain associated with the request. In this way, the applicant/beneficiary may be an individual or an entity, such as a business or the like that may transacting with another party. As good faith or part of the transaction, the applicant/beneficiary may require or desire to obtain a standby guarantee resource from a financial institution for the transaction. As such, the system may identify the applicant/beneficiary requesting the standby guarantee resource from a financial institution. Upon identification of the request, the system may generate a private block chain associated with the request and the development of the standby guarantee resource.

As illustrated in block 108, the process 100 continues by transmitting the request for the standby guarantee resource to the block chain network for the resource distribution entity for access to data for approval of the standby guarantee resource. This may include documents, account information, financial information, and the like associated with the applicant/beneficiary. This data may be posted to the block chain within the distributed network for financial institution server review for approval of the standby guarantee resource. As such, as illustrated in block 110, the process 100 continues by allowing the resource distribution entity to perform the process of approving or denying the standby guarantee resource. Upon approval, the system generates a block on the distributed ledger illustrating the approval or denial of the standby guarantee resource.

Finally, as illustrated in block 112, the process 100 is finalized by allowing the appropriate third parties to gain access to one or more blocks on the distributed ledger. The system may only allow access to specific data on the block chain network based on authentication. In this way, individuals may only have access to data on the block chain network associated with their role and/or the data that they are authorized to gain access.

FIG. 3C provides a high level process map illustrating components and blocks of network for standby guarantee resource request and deployment 150, in accordance with one embodiment of the present invention. As illustrated there are two members, member 2 152 and member 1 156. Each of the members of the network are designated a block chain node 154 and 158. The block chain nodes allow the members to access the network for standby guarantee resource applications and processing by authenticating and accessing through the application. The operator may comprise a centralized location of all responsibilities that can access through multiple locations. The operator module may include business logic and workflow applications 160 and notification engines 164. These applications may block and distribute data to the various members based on the member level. In some embodiments, each of the nodes on the private block chain are responsible for performing one or more functions to process the transaction. In particular, each node monitors the block chain for blocks that are critical to perform its task while being blocked from or otherwise not being able to visualize the blocks that are not relevant. Upon discovering a relevant block, the node performs its designated functions to process the transaction, i.e. the blocks within the block chain trigger the nodes to perform their functions. Once a block has been authenticated, a node may rely on the data record stored therein without utilizing a complex reconciliation system to confirm the data's integrity. By using the block chain to control the workflow of the transaction, the system may avoid data errors resulting from failure in communications amongst nodes and prevents the need for computing resource-intensive data reconciliation processes.

As illustrated the UI/APP application 168 allows the operator module to introduce the UI/APP into member legacy programs for member access to display documents for the standby guarantee resource for the applicant. The authentication and authorization application 162 approves member access to the network and authenticates the members for access to documents on the distributed ledger. The key management application 166 and the certificate management application 170 manages the keys and certificates for accessing the distributed network.

As further illustrated, the operator module may further include smart contract applications 172 for triggering of smart contract deployment for configurable rules compliance of the documents associated with the standby guarantee resource processing. The operator module may also comprise an application code application 174, key enclave application 182, certificate authority application 184. The operator module may further comprise software and hardware for running the block chain network. This may include network configurations 176, software 178, and developmental operations 180.

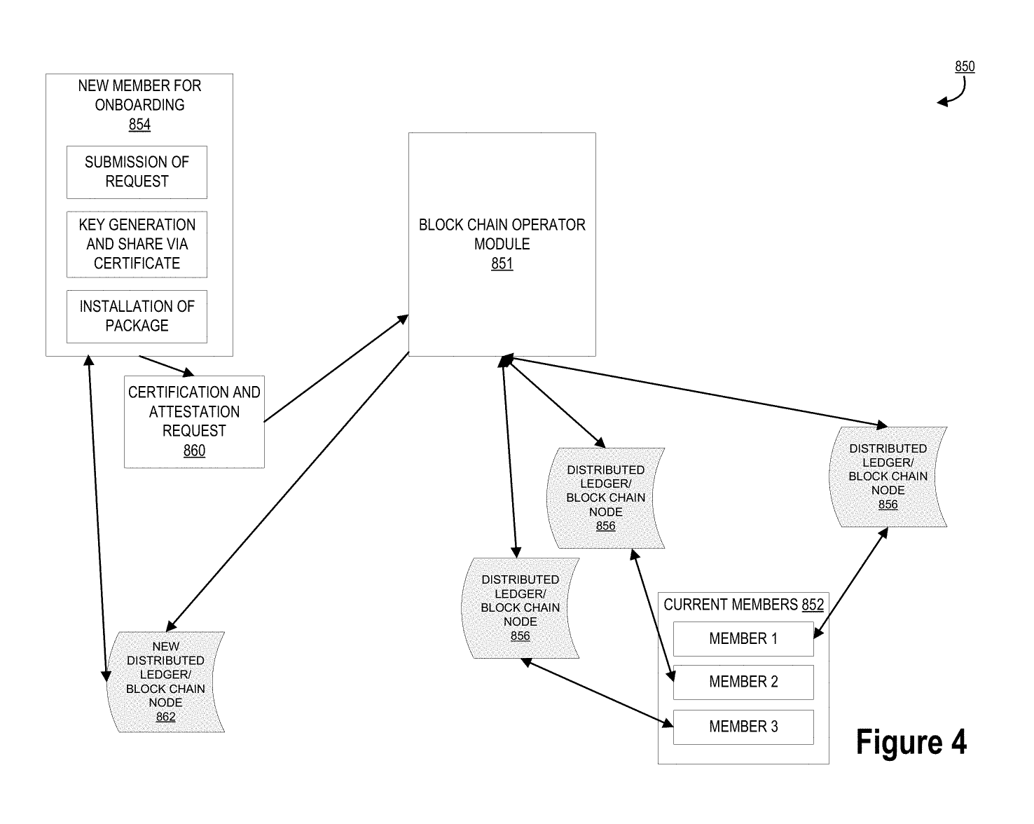

FIG. 4 provides a detailed process map illustrating standby guarantee resources member onboarding 850, in accordance with one embodiment of the present invention. As illustrated in block 851, the block chain operator module may be communicating with the various current members 852 (such as Member 1, Member 2, and Member 3) via block chain nodes 856.

The new member requesting onboarding 854 may submit a request for application to the network. The member may then generate a key and share the key via certificates. The member may then receive installation package and instructions from the block chain operator module 851 and allow the new member to perform configuration parameters for the network. As illustrated in block 860, once the member sets up the infrastructure for being a node on the block chain network, the member may send certification attestation request to the block chain operation module 851. The block chain operator module 851 may distribute the new member request to the members. The members may vote to approve the member as a new member into the network. Upon consensus being achieved for the new member, the system may update the configuration. The block chain operator module 851 may generate a new distributed ledger/block chain node 862 for the user.

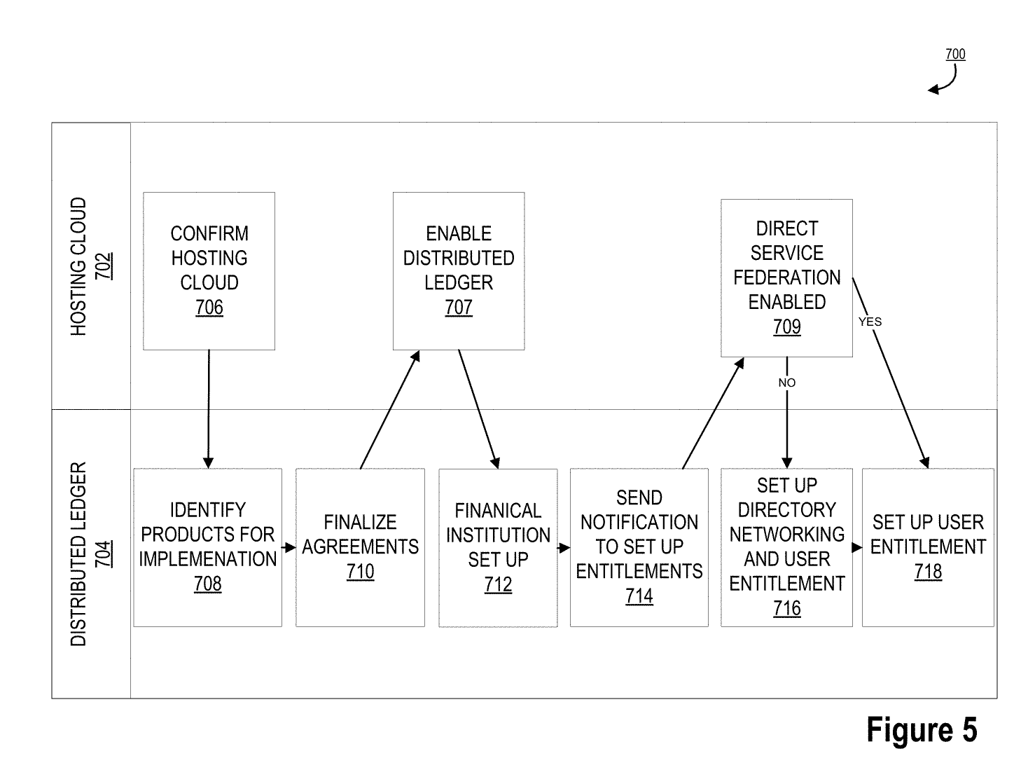

FIG. 5 provides a detailed process map for financial institution onboarding to a distributed ledger with a hosting cloud client 700, in accordance with one embodiment of the present invention. In some embodiments, the system may provide for standby guarantee resources member onboarding, in accordance with one embodiment of the present invention. In this way, the block chain operator module may be communicating with the various current members (such as Member 1, Member 2, and Member 3) via block chain nodes. The new member requesting onboarding may submit a request for application to the network. The member may then generate a key and share the key via certificates. The member may then receive installation package and instructions from the block chain operator module and allow the applicant/beneficiary to perform configuration parameters for the network. In some embodiments, once the new member sets up the infrastructure for being a node on the block chain network, the new member may send certification attestation request to the block chain operation module. The block chain operator module may distribute the new member request to the members. The members may vote to approve the new member as a new member into the network. Upon consensus being achieved for the new member, the system may update the configuration. The block chain operator module may generate a new distributed ledger/block chain node for the user.

As illustrated in FIG. 5, the hosting cloud 702 and the distributed ledger 704 of the block chain is illustrated. The hosting cloud 702 may confirm that the cloud is the hosting cloud, as illustrated in block 706. As such, the financial institution confirms the cloud as the hosting cloud and confirms its privacy as a private cloud. As illustrated in block 708, the process 700 continues by identifying the products for implementation on the distributed ledger. Any legal agreements and terms of the standby guarantee resources may also be finalized between the members on the distributed ledger, as illustrated in block 710. In this way, the system may identify the members and the terms of the standby guarantee resources. As illustrated in block 707, the members may enable the distributed ledger for the standby guarantee resources. The financial institution then reviews the documentations and finalized the set up for the processing of the standby guarantee resources, as illustrated in block 712. The distributed ledger may send notifications to financial institution administrators to set up and the applicant/beneficiary entitlements, as illustrated in block 714. The hosting cloud may then determine if the direct service federation is enabled for the processing, as illustrated in 709. If no, then they distributed ledger sets up the directory networking, as illustrated in block 716. If direct service federation is enabled the applicant/beneficiary entitlement is set up and applicant/beneficiary is notified to set up a password and authentication into the private block chain for standby guarantee resources processing.

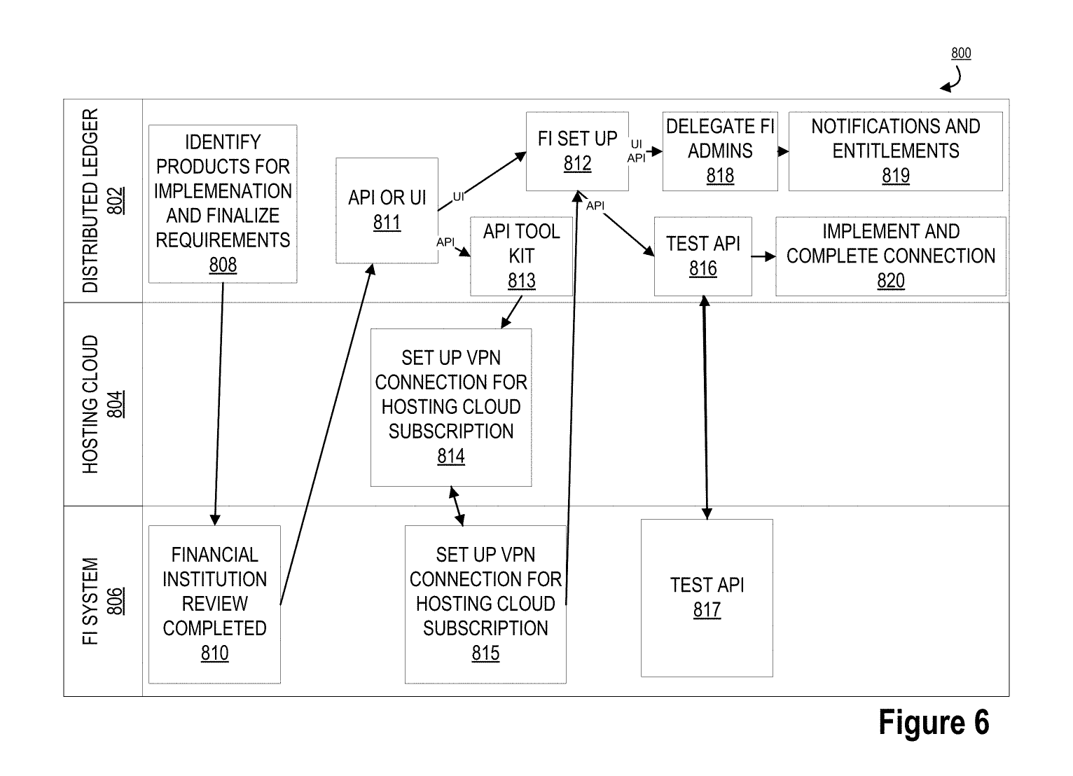

FIG. 6 provides a detailed process map for financial institution onboarding to a distributed ledger with a non-hosting cloud client 800, in accordance with one embodiment of the present invention. As illustrated in FIG. 6, the distributed ledger 802, hosting cloud 804, and financial institution system 806 interact in the process 800. The process 800 is initiated by identifying products for implementation and finalizing the legal and configurable rules requirements for the same, as illustrated in block 808. Upon finalization of the legal and configurable rules requirements the financial institution review is performed by the financial institution system, as illustrated in block 810.

Next, as illustrated in block 811, the distributed ledger determines if an API or UI is being used. If an API is used, the system provides an API tool kit, as illustrated in block 813. This tool kit is used and transmitted to the hosting cloud and financial institution system for setting up a VPN connection for all of the hosting cloud subscription, such as the members associated with the processing of the standby guarantee resources, as illustrated in block 814 and 815. The financial institution performs entity or member set up on the network, as illustrate in 812.

If an API is being used, the system may allow the distributed network and financial institution system test the API, as illustrated in block 816 and 817. After testing the API the distributed ledger nay implement the API and notify financial institutions that the hosting cloud connection has been completed, as illustrated in block 820. If a UI or an API is being used the system may delegate financial institution administrators, as illustrated in block 818 and allow the distributed ledger to send notifications to the financial administrators to set up passwords, authentication, and applicant/beneficiary entitlements, as illustrated in block 819.

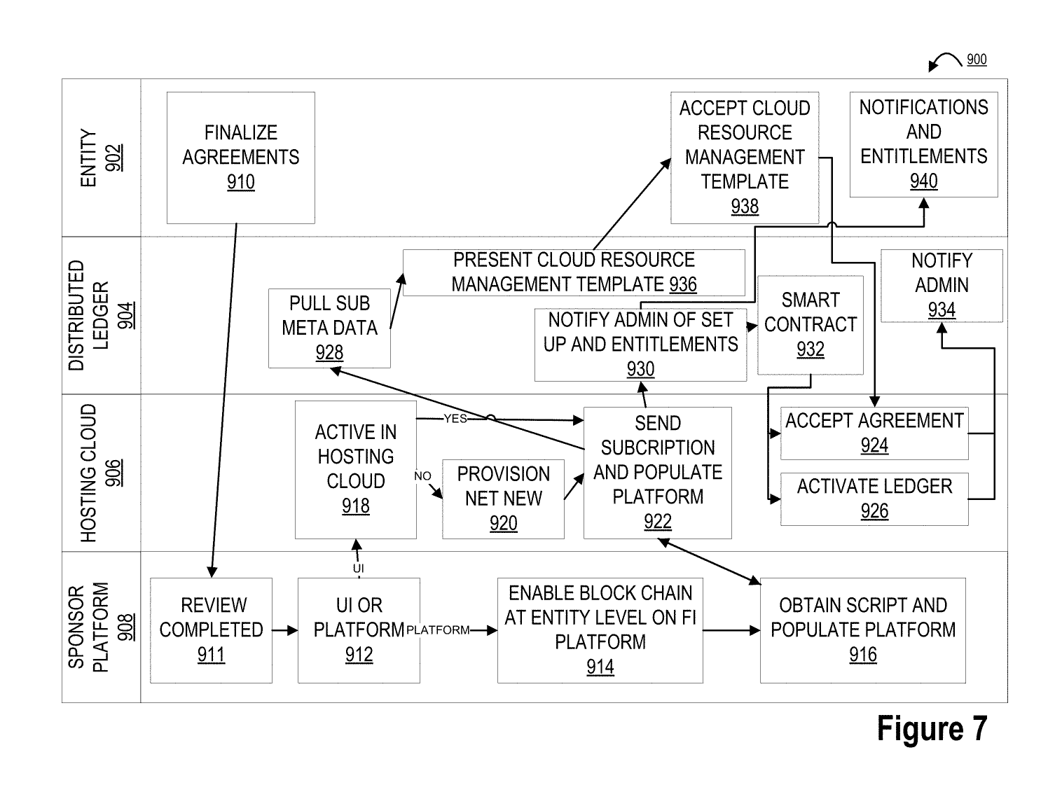

FIG. 7 provides a detailed process map for entity member onboarding to a distributed ledger with a cloud enabled hosting cloud client 900, in accordance with one embodiment of the present invention. The process 900 includes an entity 902 that may be one or more potential members associated with the standby guarantee resources. The process 900 includes a distributed ledger 904, hosting cloud 906, and a sponsor platform 908. In some embodiments, the sponsor platform 908 may be a resource distribution entity, such as a financial institution platform. The process 900 is initiated by finalizing agreements with the member entities to determine the legal agreements and terms of the standby guarantee resources. The sponsor platform then performs compliance reviews, illustrated in block 911. The system determines if a UI or platform exists for the onboarding, as illustrated in block 912. If a platform, the sponsor platform enables the block chain at an entity level on the platform, as illustrated in block 914. The sponsor platform may obtain scripts and populate the platform, as illustrated in block 916.

If a UI, the system may determine if the UI is active in the hosting cloud, as illustrated in block 918. If it isn't active in the hosting cloud, the system may provision a net new UI, as illustrated in block 920. At that point, or if the UI is active in the hosting cloud, the system may send subscriptions and populate the platform, as illustrated in block 922. The system may then pull subscription metadata and set administrators to set up, as illustrated in block 928. The system may present the cloud resource management template at the distributed ledger and allow entities to accept the terms, as illustrated in block 936 and 938. The hosting cloud 906 may accept the agreement 924 and notify the administrators as illustrated in block 934.

As illustrated in block 930 and 940, the distributed ledger may notify the administrator to set up passwords and applicant/beneficiary entitlements. The system may then introduce smart contracts 932, accept agreements 923 and activate the ledger 926 on the hosting cloud.

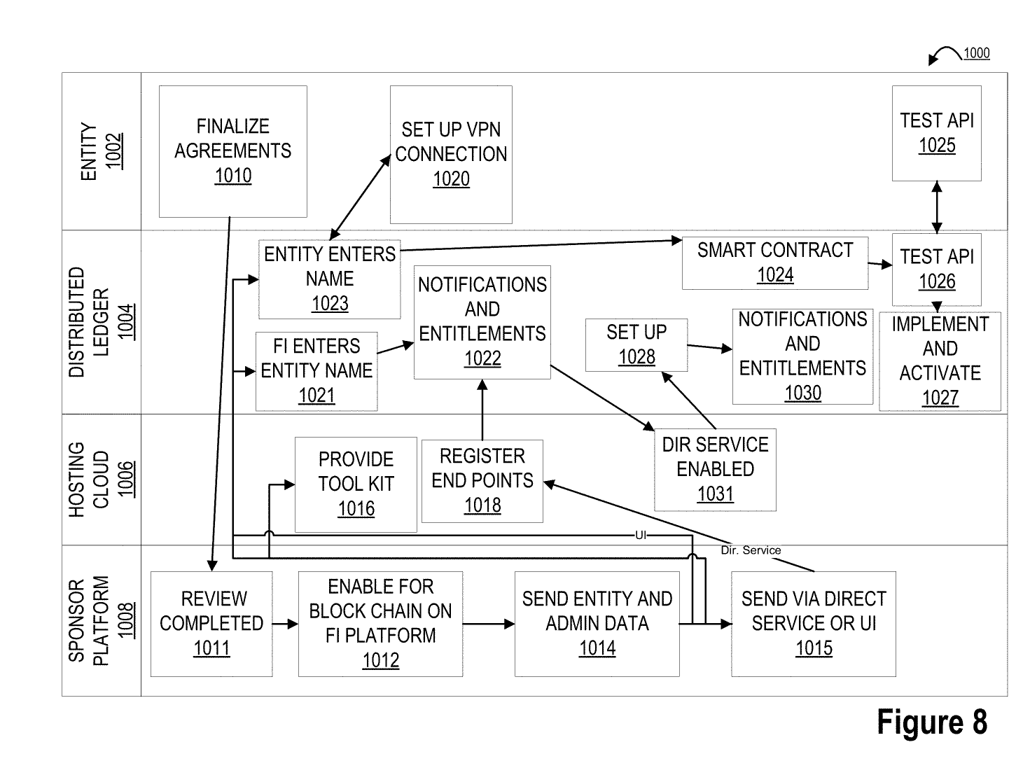

FIG. 8 provides a detailed process map for entity onboarding to a distributed ledger with a non-hosting cloud enabled client 1000, in accordance with one embodiment of the present invention. The process 1000 includes an entity 1002 that may be one or more potential members associated with the standby guarantee resources that may include a beneficiary/applicant or the like. The process 1000 includes a distributed ledger 1004, hosting cloud 1006, and a sponsor platform 1008.

The process 1000 is initiated by finalizing agreements with the member entities to determine the legal agreements and terms of the standby guarantee resources. The financial system platform then performs compliance reviews, illustrated in block 1011. Next, as illustrated in block 1012, the process 1000 continues by enabling the block chain on the sponsor platform. Next, as illustrated in block 1014 the sponsor platform sends entity and administrator data and sends via direct service or UI, as illustrated in block 1015. If a direct service is used, the host cloud may register end points as illustrated in block 1018. As illustrated in block 1020, a VPN connection may be set up. As illustrated in block 1022, the distributed ledger may send notifications to the administrator to set up a password and applicant/beneficiary entitlements. If a UI is used in block 1015, the system allows the member to enter the entity name, as illustrated in block 1021. Then, as illustrated in block 1022, the distributed ledger may send notifications to the administrator to set up a password and applicant/beneficiary entitlements.

If there is no entity data name, the sponsor platform may, via the distributed ledger to request entity to enter names, as illustrated in block 1023. The distributed ledger continues to post smart contracts, as illustrated in block 1024. The entity and the distributed ledger may test the API, as illustrated in block 1025 and 1026. Finally, as illustrated in block 1027, the system may implement and activate on the distributed ledger.

Referring back to block 1022, the distributed ledger may send notifications to the administrator to set up a password and applicant/beneficiary entitlements and allows the host cloud to trigger enablement of the direct service, as illustrated in block 1031. As illustrated in block 1028 the distributed network allows set up of applicant/beneficiary direct service and administrator completion of manual set up if necessary. Finally, notifications and entitlements maybe presented on the distributed ledger, as illustrated in block 1030.

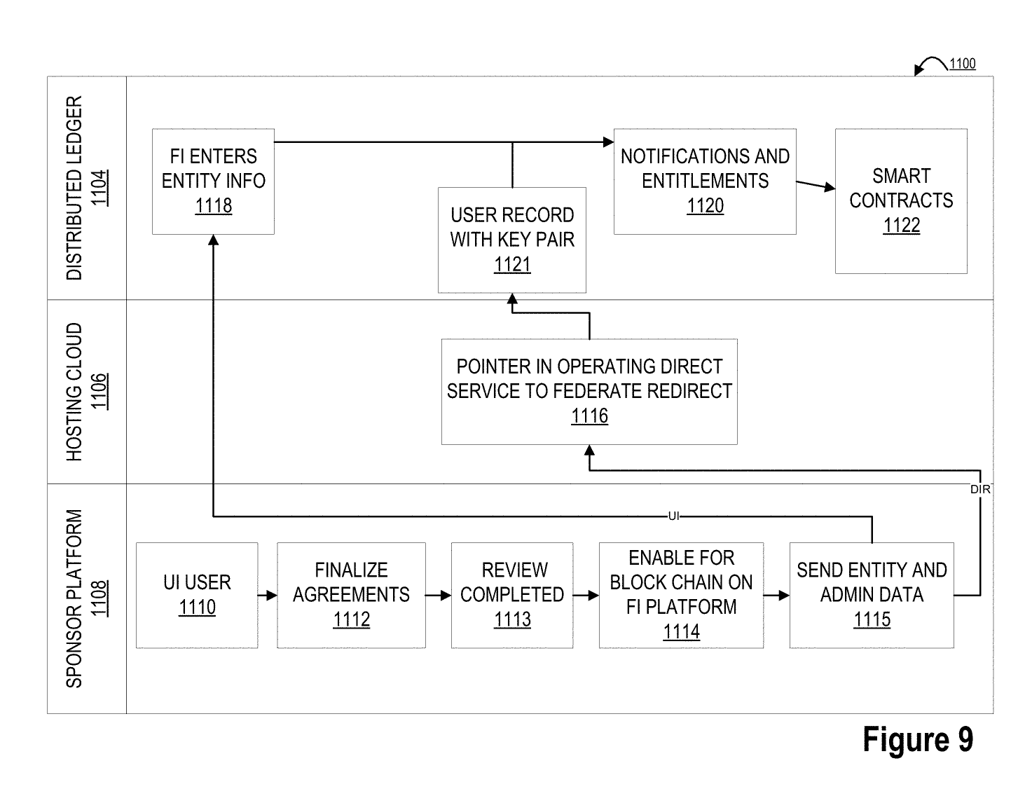

FIG. 9 provides a detailed process map for entity onboarding to a distributed ledger 1100, in accordance with one embodiment of the present invention. The process 1100 includes a sponsor platform 1108, a hosting cloud 1106, and a distributed ledger 1104 associated with the block chain. As illustrated, the process 1100 is initiated by identifying an applicant/beneficiary accessing via a UI at the sponsor platform, as illustrated in block 1110. The sponsoring financial institution may finalize the legal agreements and terms of the standby guarantee resources, as illustrated in block 1112. The sponsoring financial institution may further preform reviews and complete those reviews, as illustrated in block 1113.

Next, as illustrated in block 1114, the process 1100 continues by enabling the block chain on the sponsor platform. As illustrated in block 1115, the sponsoring financial institution may send the member entity data and administrator data. If the data is transmitted via direct service, the hosting cloud may provide pointer in operating direct service to perform a federated redirect, as illustrated in block 1116. Next, the applicant/beneficiary record is associated with the key pair on the distributed ledger, as illustrated in block 1121. In some embodiments, if the data is transmitted via UI, the distributed ledger allows the financial institution to enter entity information, as illustrated in block 1118.

The process 1100 continues by providing notifications and entitlements, as illustrated in block 1120. Finally smart contracts are generated for processing the standby guarantee resources via the distributed ledger, as illustrated in block 1122.

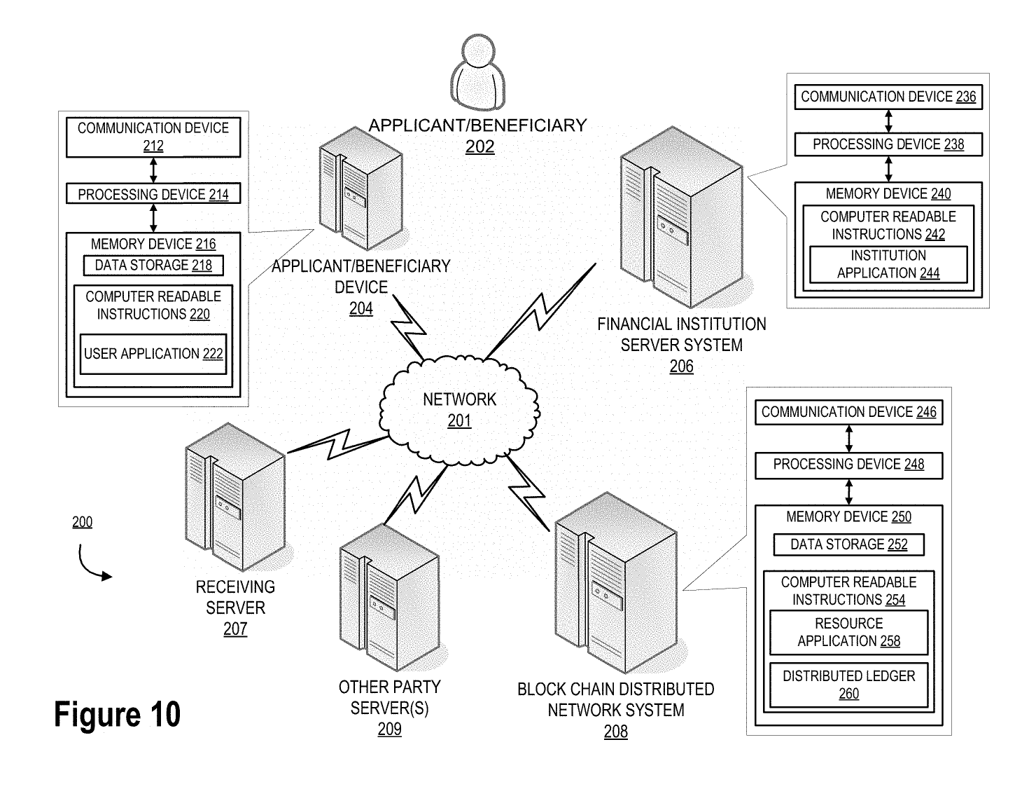

FIG. 10 provides a unique system that includes specialized servers and system communicably linked across a distributive network of nodes required to perform the functions of requesting, generating, utilizing, and deploying standby guarantee resource via a distributed ledger within a block chain network.

FIG. 10 provides a standby guarantee resource system environment 200, in accordance with one embodiment of the present invention. As illustrated in FIG. 10, the block chain distributed network system 208 is operatively coupled, via a network 201 to the applicant/beneficiary system 204, receiving server 207, other party servers 209, and to the financial institution server system 206. In this way, the block chain distributed network system 208 can send information to and receive information from the applicant/beneficiary device/sending server 204, receiving server 207, other party servers 209, and the financial institution server system 206. FIG. 10 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the applicant/beneficiary 202 is an individual or entity that requests a standby guarantee resource for the applicant/beneficiary and/or for a third party the applicant/beneficiary may be transacting with where the transaction may require a good faith generation of a standby guarantee resource. In some embodiments, the applicant/beneficiary 202 has an applicant/beneficiary device, such as a mobile phone, tablet, or the like that may interact with and control the distribution of files from the sending server to the receiving server 207, financial institution server system 206, or the block chain distributed network system 208. FIG. 10 also illustrates an applicant/beneficiary system 204. The applicant/beneficiary device/sending server 204 may be, for example, a server or the like in connection with an applicant/beneficiary device, such as a desktop computer, laptop, tablet, cellular telephone, or the like. The applicant/beneficiary device/sending server 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the financial institution server system 206, the receiving server 207, other party servers 209, and the block chain distributed network system 208. As such, the communication device 212 generally comprises a modem, server, or other device for communicating with other devices on the network 201.

The applicant/beneficiary device/sending server 204 comprises computer-readable instructions 220 and data storage 218 stored in the memory device 216, which in one embodiment includes the computer-readable instructions 220 of an applicant/beneficiary application 222. In some embodiments, the applicant/beneficiary application 222 allows an applicant/beneficiary 202 to transmit files from one server to another for processing and generation of a standby guarantee resource.

The receiving server 207 comprises the same or similar features as the applicant/beneficiary device 204 and is the server receiving the files being transmitted. Including comprising computer-readable instructions and data storage stored in the memory device, which in one embodiment includes the computer-readable instructions for one or more applications. In some embodiments, the one or more applications allow for receiving of files or blocks from one or more servers.

The other party servers 209 comprises the same or similar features as the applicant/beneficiary device 204 and is the server receiving the files being transmitted. Including comprising computer-readable instructions and data storage stored in the memory device, which in one embodiment includes the computer-readable instructions for one or more applications. In some embodiments, the one or more applications allow for receiving of files or blocks from one or more servers.

As further illustrated in FIG. 10, the block chain distributed network system 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the financial institution server system 206, receiving server 207, other party servers 209, and the applicant/beneficiary system 204. As such, the communication device 246 generally comprises a modem, server, or other device for communicating with other devices on the network 201.

As further illustrated in FIG. 10, the block chain distributed network system 208 comprises computer-readable instructions 254 stored in the memory device 250, which in one embodiment includes the computer-readable instructions 254 of a resource application 258. In some embodiments, the memory device 250 includes data storage 252 for storing data related to the system environment.

Embodiments of the block chain distributed network system 208 may include multiple systems, servers, computers or the like maintained by one or many entities. FIG. 10 merely illustrates one of those systems that, typically, interacts with many other similar systems to form the block chain. In some embodiments, the financial institution server system 206 may be part of the block chain. Similarly, in some embodiments, the block chain distributed network system 208 is part of the financial institution server system 206. In other embodiments, the financial institution server system 206 is distinct from the block chain distributed network system 208.

In one embodiment of the block chain distributed network system 208 the memory device 250 stores, but is not limited to, a resource application 258 and a distributed ledger 260. In some embodiments, the distributed ledger 260 stores data including, but not limited to, the block chains for standby guarantee resource requesting, generating, and completing.

In one embodiment of the invention, both the resource application 258 and the distributed ledger 260 may associate with applications having computer-executable program code that instructs the processing device 248 to operate the network communication device 246 to perform certain communication functions involving described herein. In one embodiment, the computer-executable program code of an application associated with the distributed ledger 260 and resource application 258 may also instruct the processing device 248 to perform certain logic, data processing, and data storing functions of the application.

The processing device 248 is configured to use the communication device 246 to gather data, such as data corresponding to transactions, blocks or other updates to the distributed ledger 260 from various data sources such as other block chain network system. The processing device 248 stores the data that it receives in its copy of the distributed ledger 260 stored in the memory device 250.

As illustrated in FIG. 10, the financial institution server system 206 is connected to the block chain distributed network system 208 and is associated with a financial institution network. In this way, while only one financial institution server system 206 is illustrated in FIG. 10, it is understood that multiple network systems may make up the system environment 200. The financial institution server system 206 generally comprises a communication device 236, a processing device 238, and a memory device 240. The financial institution server system 206 comprises computer-readable instructions 242 stored in the memory device 240, which in one embodiment includes the computer-readable instructions 242 of an institution application 244. The financial institution server system 206 may communicate with the block chain distributed network system 208. While the block chain distributed network system 208 may communicate with the financial institution server system 206 via a secure connection generated for secure encrypted communications between the two systems. The financial institution server system 206 may be associated with a financial institution. In some embodiments as disclosed herein a financial institution may also be referred to as a resource distribution entity.

It is understood that the servers, systems, and devices described herein illustrate one embodiment of the invention. It is further understood that one or more of the servers, systems, and devices can be combined in other embodiments and still function in the same or similar way as the embodiments described herein.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for onboarding parties for standby guarantee resources generation and processing, the system comprising:
a memory device with computer-readable program code stored thereon;
a communication device;
a processing device operatively coupled to the memory device and the communication device, wherein the processing device is configured to execute the computer-readable program code to:
generate a block chain network for a standby guarantee resources generation and processing;
enable access to the block chain network on a financial institution platform;
identify one or more parties of a transaction and allow access to a distributed ledger associated with the standby guarantee resources generation and processing and transmit entity and administrator data via direct service or UI;
onboard and off boarding of parties via authentication of the parties as members;
identify access of parties and provide tool kit for member access of a distributed ledger based on access via API, UI, or direct service;
identify a request for the standby guarantee resources and generate one or more blocks on a distributed ledger based on the request; and
generate a smart contract for processing the standby guarantee resources for triggering of member access and steps for processing the standby guarantee resources.

2. The system of claim 1, wherein parties are identified as entities required for processing and approving the standby guarantee resources or third parties associated with a transaction with an applicant/beneficiary wherein the transaction includes the standby guarantee resources.

3. The system of claim 1, wherein enabling access to the block chain network on a financial institution platform further comprises enabling access to a distributed network on the block chain network via a host or non-host cloud.

4. The system of claim 1, further comprising:
presenting the request to one or more parties on the block chain network based on authorization access to each of the one or more blocks;
allowing processing of the standby guarantee resources via data distribution from the one or more parties; and
providing real-time enforcement of configurable rules and contractual terms via distributive ledger visualization of the standby guarantee resources.

5. The system of claim 1, wherein the block chain network provides transparency for all parties of the transaction for real-time enforcement of configurable rules and contractual terms via smart contract and routing integration.

6. The system of claim 1, further comprising allowing processing of the standby guarantee resources via data distribution from the one or more parties further comprises generation of an application for the standby guarantee resources from a resource distribution entity for applicant/beneficiary completion and matching information on the application to documentation generated from the applicant/beneficiary and distributed via the distributed ledger.

7. The system of claim 1, wherein the standby guarantee resources further comprises a standby letter of credit for an entity.

8. A computer program product for onboarding parties for standby guarantee resources generation and processing, the computer program product comprising at least one non-transitory computer-readable medium having computer-readable program code portions embodied therein, the computer-readable program code portions comprising:
an executable portion configured for generating a block chain network for a standby guarantee resources generation and processing;
an executable portion configured for enabling access to the block chain network on a financial institution platform;
an executable portion configured for identifying one or more parties of a transaction and allow access to a distributed ledger associated with the standby guarantee resources generation and processing and transmit entity and administrator data via direct service or UI;
an executable portion configured for onboarding and off boarding of parties via authentication of the parties as members;
an executable portion configured for identifying access of parties and provide tool kit for member access of a distributed ledger based on access via API, UI, or direct service;
an executable portion configured for identifying a request for the standby guarantee resources and generate one or more blocks on a distributed ledger based on the request; and
an executable portion configured for generating a smart contract for processing the standby guarantee resources for triggering of member access and steps for processing the standby guarantee resources.

9. The computer program product of claim 8, wherein parties are identified as entities required for processing and approving the standby guarantee resources or third parties associated with a transaction with an applicant/beneficiary wherein the transaction includes the standby guarantee resources.

10. The computer program product of claim 8, wherein enabling access to the block chain network on a financial institution platform further comprises enabling access to a distributed network on the block chain network via a host or non-host cloud.

11. The computer program product of claim 8, further comprising:
an executable portion configured for presenting the request to one or more parties on the block chain network based on authorization access to each of the one or more blocks;
an executable portion configured for allowing processing of the standby guarantee resources via data distribution from the one or more parties; and
an executable portion configured for providing real-time enforcement of configurable rules and contractual terms via distributive ledger visualization of the standby guarantee resources.

12. The computer program product of claim 8, wherein the block chain network provides transparency for all parties of the transaction for real-time enforcement of configurable rules and contractual terms via smart contract and routing integration.

13. The computer program product of claim 8, further comprising an executable portion configured for allowing processing of the standby guarantee resources via data distribution from the one or more parties further comprises generation of an application for the standby guarantee resources from a resource distribution entity for applicant/beneficiary completion and matching information on the application to documentation generated from the applicant/beneficiary and distributed via the distributed ledger.

14. A computer-implemented method for onboarding parties for standby guarantee resources generation and processing, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
generating a block chain network for a standby guarantee resources and processing;
enabling access to the block chain network on a financial institution platform;
identifying one or more parties of a transaction and allow access to a distributed ledger associated with the standby guarantee resources generation and processing and transmit entity and administrator data via direct service or UI;
onboarding and off boarding of parties via authentication of the parties as members;
identifying access of parties and provide tool kit for member access of a distributed ledger based on access via API, UI, or direct service;
identifying a request for the standby guarantee resources and generate one or more blocks on a distributed ledger based on the request; and
generating a smart contract for processing the standby guarantee resources for triggering of member access and steps for processing the standby guarantee resources.

15. The computer-implemented method of claim 14, wherein parties are identified as entities required for processing and approving the standby guarantee resources or third parties associated with a transaction with an applicant/beneficiary wherein the transaction includes the standby guarantee resources.

16. The computer-implemented method of claim 14, wherein enabling access to the block chain network on a financial institution platform further comprises enabling access to a distributed network on the block chain network via a host or non-host cloud.

17. The computer-implemented method of claim 14, further comprising:
presenting the request to one or more parties on the block chain network based on authorization access to each of the one or more blocks;
allowing processing of the standby guarantee resources via data distribution from the one or more parties; and
providing real-time enforcement of configurable rules and contractual terms via distributive ledger visualization of the standby guarantee resources.

18. The computer-implemented method of claim 14, wherein the block chain network provides transparency for all parties of the transaction for real-time enforcement of configurable rules and contractual terms via smart contract and routing integration.
